(19) United States
(12) Patent Application Publication
(10) Pub. No.: US 2016/0166979 A1
(43) Pub. Date: Jun. 16, 2016

(54) GAS SEPARATION MEMBRANE COMPRISING SUPER BASE

(71) Applicant: GWANGJU INSTITUTE OF SCIENCE AND TECHNOLOGY, Gwangju (KR)

(72) Inventors: Ji-Woong PARK, Gwangju (KR); A-Ran LEE, Gwangju (KR); Ramachandran RAJAMANICKAM, Gwangju (KR); Hyung-Soo KIM, Gwangju (KR)

(21) Appl. No.: 14/938,753

(22) Filed: Nov. 11, 2015

Related U.S. Application Data
(60) Provisional application No. 62/078,409, filed on Nov. 11, 2014.

(30) Foreign Application Priority Data
Mar. 17, 2015 (KR) 10-2015-0036526

(51) Int. Cl. B01D 53/22; B01D 69/14; B01D 67/00; B01D 71/38

(52) U.S. Cl. CPC B01D 53/228; B01D 71/38; B01D 69/141; B01D 67/0009; B01D 67/0006; B01D 2323/30; B01D 2325/12

(57) ABSTRACT

The present invention provides a blend membrane capable of being used for separation of carbon dioxide. The blend membrane according to the present invention is capable of being used for blocking permeation of carbon dioxide.

### BACKGROUND

1. Technical Field

The present invention relates to a gas separation membrane comprising a superbase, and more specifically, to a blend membrane for gas separation comprising a polymer including hydroxyl groups in a main chain and a superbase.

2. Description of the Related Art

Currently, as a concentration of carbon dioxide in the atmosphere is globally increased, global warming occurs to increase a temperature of the earth. In order to overcome these environmental issues, interest in a technology of capturing and storing carbon dioxide (hereinafter, referred to as a technology of Carbon Dioxide Capture & Storage (CCS)) is also rising. The CCS technology is divided into a capture technology of capturing carbon dioxide from emission source and a storage technology of storing carbon dioxide in the ocean or into the soil, and the capture technology of the CCS technology includes an absorption process, an adsorption process, a cryogenic process, a membrane separation process, etc.

In general, among the CCS technologies, the absorption process and the adsorption method are largely commercialized, but these processes essentially require high-energy and high cost. However, the membrane separation process is environmentally friendly, and has low installation costs and low operating costs since it requires low energy, unlike the absorption process and the adsorption process. Among many materials, a polymer is widely used for the membrane separation process due to excellent processability and low cost.

In addition, when a material forming a complex in response to specific gas is introduced into the membrane, permeability and selectivity of the specific gas may be increased. In particular, research into a technology of separating carbon dioxide by using the material forming the complex in response to carbon dioxide, has been actively ongoing, but satisfactory results have not come out yet.

### RELATED ART DOCUMENT

(Non-Patent Document 1) Energy Procedia, 2013, 37, 961-968
(Non-Patent Document 2) Chem. Sci., 2014, 5, 2843
(Non-Patent Document 3) Energy Environ. Sci., 2008, 1, 487-493
(Non-Patent Document 4) NATURE, 2005, 436, 1102

### SUMMARY

It is an aspect of the present invention to provide a blend membrane capable of being used for separation of carbon dioxide. The blend membrane according to the present invention is capable of being used for blocking permeation of carbon dioxide.

In accordance with one aspect of the present invention, a blend membrane for gas separation includes: (a) a polymer including hydroxyl groups in a main chain; and (b) a superbase.

In accordance with another aspect of the present invention, a method for blocking carbon dioxide includes: (A) permeating a mixed gas including carbon dioxide through various blend membranes according to various exemplary embodiments of the present invention.

In accordance with another aspect of the present invention, a method for preparing a blend membrane includes: (B) drying a solution containing a polymer including hydroxyl groups in a main chain and a superbase.

### BRIEF DESCRIPTION OF DRAWINGS

FIG. 1 shows reactivity of a carbon dioxide absorbing solution consisting of a guanidine derivative, PVA and DMSO. (a) Reaction mechanism, (b) Absorption curve, (c) Gel obtained by absorption of carbon dioxide.

FIG. 2 is scanning electron microscope (SEM) images of a guanidine derivative/PVA blend membrane. (a) PVA membrane, (b) Guanidine derivative/PVA blend membrane

FIG. 3 is carbon dioxide absorption curves depending on ratios of functional groups in the guanidine derivative/PVA blend membrane.

FIG. 4 is a gas chromatography graph of the guanidine derivative/PVA blend membrane.

FIG. 5 shows change in selectivity of the guanidine derivative/PVA blend membrane over time.

FIG. 6 is a schematic view showing gas separation of the guanidine derivative/PVA blend membrane.

FIG. 7 is FT-IR curve of the guanidine derivative/PVA blend membrane (Before carbon dioxide permeates, After carbon dioxide permeates).

FIG. 8 is a graph showing permeability of single gas of the guanidine derivative/PVA blend membrane.

FIG. 9 is SEM images of guanidine derivative/PVA blend membranes treated with carbon dioxide. (a) 10 wt % of guanidine derivative, (b) 20 wt % of guanidine derivative.

FIG. 10 is FT-IR analysis results of the guanidine derivative/PVA blend membrane treated with carbon dioxide (Guanidine derivative/PVA blend membrane, Guanidine derivative/PVA blend membrane treated with carbon dioxide).

FIG. 11 is a gas chromatography graph of the guanidine derivative/PVA blend membrane.

FIG. 12 shows integral values of nitrogen peaks and carbon dioxide peaks on GC graphs over time. (a) membrane to which 5 wt % of guanidine derivative is added, (b) membrane to which 10 wt % of guanidine derivative is added.

FIG. 13 shows selectivity for nitrogen, of the guanidine derivative/PVA blend membrane treated with carbon dioxide.

### DETAILED DESCRIPTION

Hereinafter, various aspects and exemplary embodiments of the present invention will be described in detail.

In accordance with one aspect of the present invention, a blend membrane includes: (a) a polymer including hydroxyl groups in a main chain; and (b) a superbase.

Various blend membranes according to various exemplary embodiments of the present invention may be used as a gas separation membrane.

According to an exemplary embodiment of the present invention, the superbase is selected from the group consisting of guanidine-based compounds, amidine-based compounds, or mixtures thereof.

Examples of the guanidine-based compound usable in the present invention include the following compounds, but the present invention is not limited thereto:

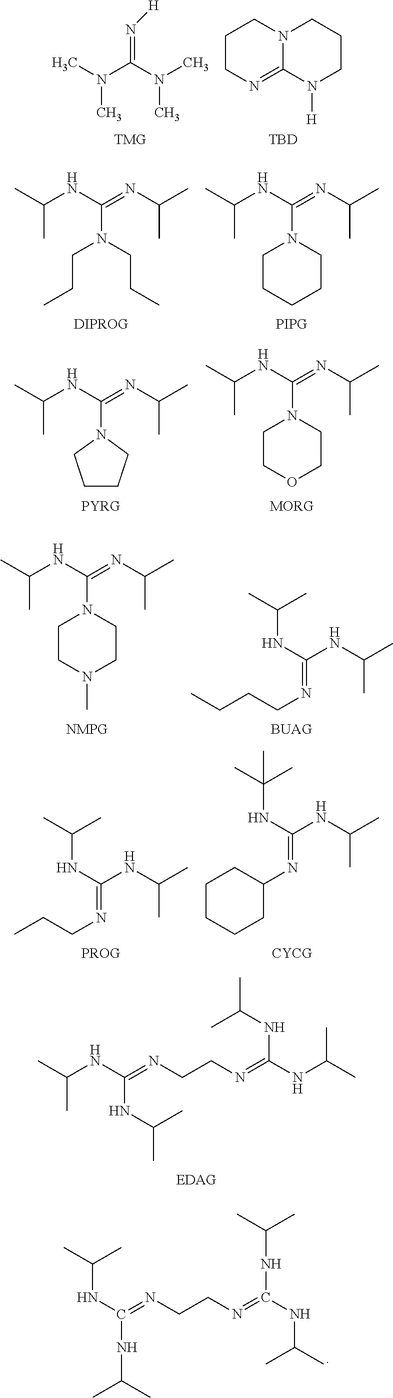

Further, examples of the amidine-based compound usable in the present invention include the following compounds, but the present invention is not limited thereto:

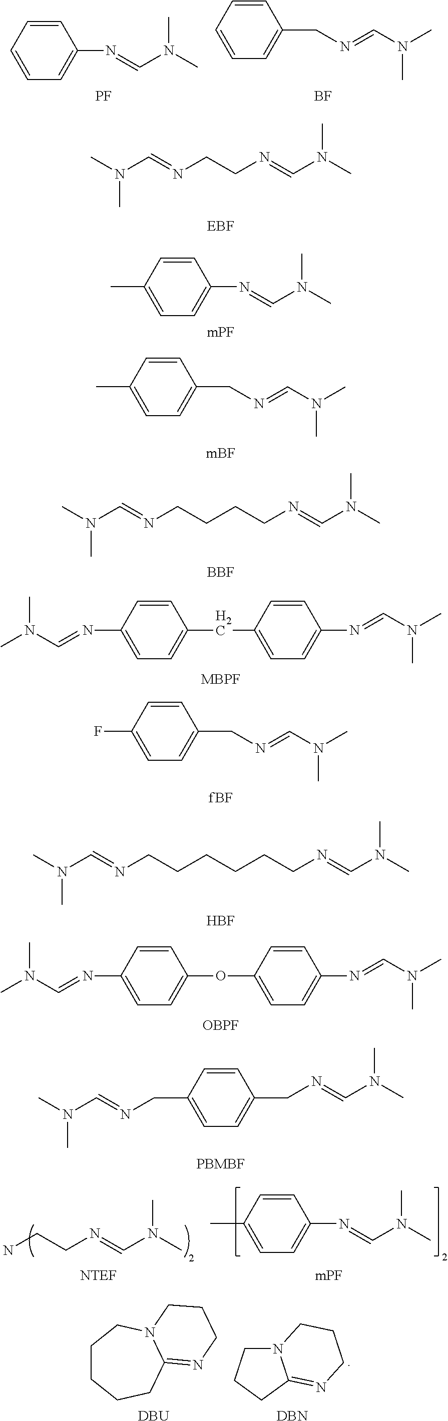

According to another exemplary embodiment of the present invention, the polymer is a polymer including vinyl alcohol as a repeating unit. The polymer includes polyvinyl alcohol (PVA) as a representative example, but is not limited thereto, and may include vinyl alcohol (VA) as a repeating unit. In particular, the polymer may include a random copolymer including vinyl alcohol and at least one repeating unit other than vinyl alcohol, an alternating copolymer, and a block copolymer.

Examples of the polymer usable in the present invention include the following compounds, but the present invention is not limited thereto:

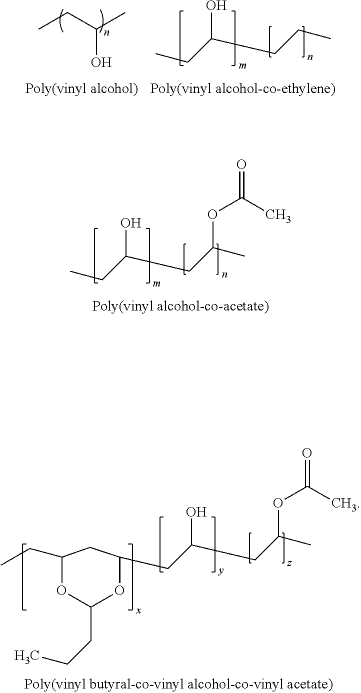

According to still another exemplary embodiment of the present invention, there is provided a blend membrane in which some of hydroxyl groups of the polymer are carbonated. Since some of the hydroxyl groups of the polymer are carbonated, it is advantageous in that selectivity to nitrogen is capable of being increased.

According to still another exemplary embodiment of the present invention, the blend membrane has an effective peak for C═N—H⁺ functional group and an effective peak for OCO— functional group in FT-IR analysis results.

According to still another exemplary embodiment of the present invention, the blend membrane has an effective peak for C═N—H⁺ functional group at 1700 cm⁻¹ to 1750 cm⁻¹ and an effective peak for OCO— functional group at 900 cm⁻¹ to 1000 cm⁻¹ in FT-IR analysis results.

According to still another exemplary embodiment of the present invention, the blend membrane is used for blocking permeation of carbon dioxide. That is, it is confirmed that when the membrane has the above-described effective peak, permeation of carbon dioxide is almost fully and completely capable of being blocked, but when a membrane does not have the above-described effective peak, an effect in which permeation of carbon dioxide is blocked is rapidly deteriorated.

In accordance with another aspect of the present invention, a method for blocking carbon dioxide includes: (A) permeating a mixed gas including carbon dioxide through various blend membranes according to various exemplary embodiments of the present invention.

In particular, the blend membrane preferably has an effective peak for C═N—H⁺ functional group at 1700 cm⁻¹ to 1750 cm⁻¹ and an effective peak for OCO— functional group at 900 cm⁻¹ to 1000 cm⁻¹ in FT-IR analysis results.

Here, preferably, the mixed gas does not include water vapor, but water vapor may be included at a small content as long as the content of water vapor in the mixed gas is not high enough to cause deformation of the polymer in the blend membrane by moisture.

In accordance with another aspect of the present invention, a method for preparing a blend membrane includes: (B) drying a solution containing a polymer including hydroxyl groups in a main chain and a superbase, under nitrogen atmosphere.

In accordance with another aspect of the present invention, a method for preparing a blend membrane includes: (B) drying a solution containing a polymer including hydroxyl groups in a main chain and a superbase, under carbon dioxide atmosphere.

According to an exemplary embodiment of the present invention, before step (B), the method may further include: (A) blowing carbon dioxide into the solution containing the polymer including a hydroxyl group in the main chain and the superbase. It is confirmed that the step of blowing the carbon dioxide carbonates the entire membrane, such that selectivity of the membrane prepared with the treatment with carbon dioxide is about 100 times increased as compared to a guanidine derivative/PVA blend membrane prepared without the treatment with carbon dioxide.

Hereinafter, the present invention will be described in detail through the following Examples; however, it is not construed as limiting the scope or the spirit of the present invention. In addition, as long as a person skilled in the art practices the present invention based on the disclosed description of the present invention including the following examples, it is obvious that the present invention may be easily practiced by a person skilled in the art even though testing results are not specifically provided, and it is intended that the present invention covers these changes and modifications included in the appended claim.

### EXAMPLE

### Preparation Example

### Synthesis of Guanidine Derivative Having Two Functional Groups

1 mol of diethylene amine and 2.3 mol of carbodiimide were mixed in a reactor under nitrogen atmosphere, the reactor was completely covered so that other gases except for nitrogen did not enter the reactor, and the mixture was reacted for about 10 hours. After the reaction was completed, all of unreacted carbodiimides were removed by vacuum drying, and as a result, a guanidine derivative having a solid state at room temperature was obtained. It was confirmed from ¹H-NMR that unreacted materials were not present, but only the resultant materials were present.

### Preliminary Test Example 1

### Absorption of Carbon Dioxide by Organic Absorbent Including Guanidine Derivative and PVA

In order to confirm whether the reaction with carbon dioxide was generated in the blend membrane, an organic absorbing solution was prepared by mixing a guanidine derivative, PVA, and dimethyl sulfoxide (DMSO), and carbon dioxide was injected thereinto at 30° C. at a rate of 10 mL/min.

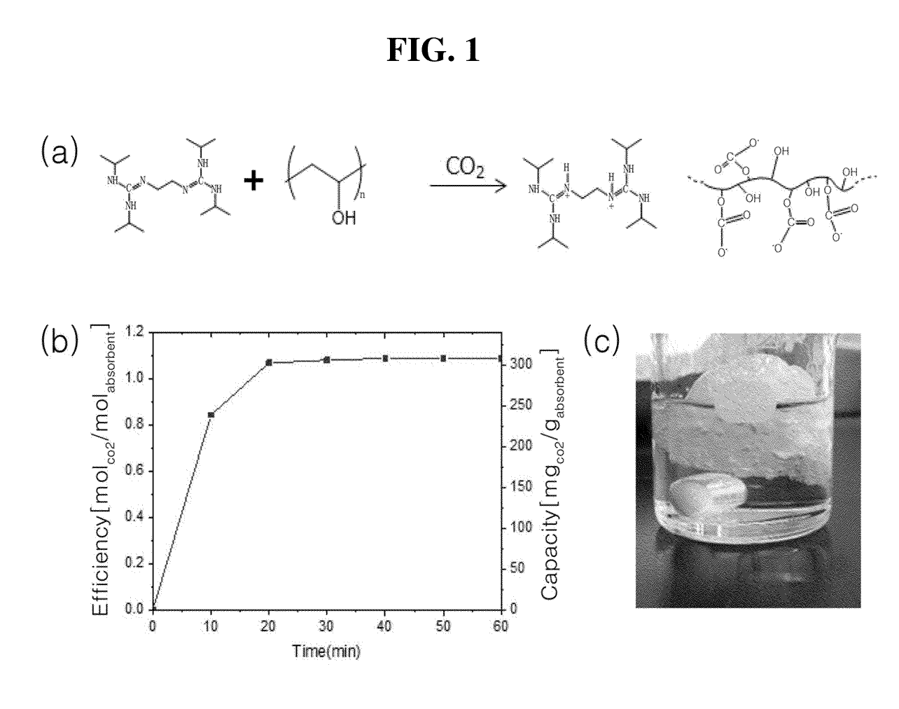

Guanidine/PVA absorbs carbon dioxide according to the mechanism shown in FIG. 1(a). FIG. 1(b) is an Absorption curve of carbon dioxide, and it may be appreciated that carbon dioxide is possible to be absorbed at a rapid rate. In addition, it was confirmed that guanidine, PVA and carbon dioxide reacted to form guanidinium carbonate, and a gel was formed by crosslinking between the PVA chains while absorbing carbon dioxide (see FIG. 1(c)).

### Example 1

### Preparation of Blend Membrane Including Guanidine Derivative and PVA (Guanidine Derivative and PVA Blend Membrane)

PVA was purchased and dried for 12 hours at 100° C. to remove moisture. PVA was mixed with deionized water, and heated at 90° C. to be dissolved. When a clear solution was formed, various contents (10 wt % to 40 wt %) of guanidine derivatives were added thereto, and stirred until each guanidine derivative was completely dissolved. The amount of the guanidine derivative and PVA was adjusted to about 30 wt % based on total weight of water/guanidine/PVA, and accordingly, solutions each having significantly high viscosity were prepared. Each solution of about 2 mL was poured onto a polystyrene substrate or a polyethylene substrate, and casted to have a uniform thickness by a doctor blade method. Each obtained product was dried under nitrogen atmosphere for 12 hours at 50° C. to obtain membranes each having a thickness of about 20 μm to 30 μm.

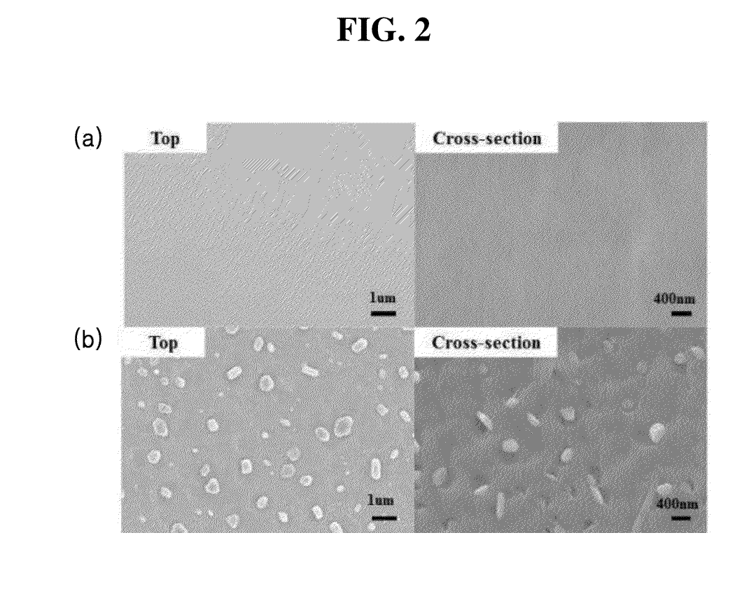

FIG. 2(a) is a scanning electron microscope (SEM) image of a PVA film to which the guanidine derivative is not added, and FIG. 2(b) is a SEM image of the guanidine derivative/PVA blend membrane. It could be confirmed that the guanidine derivative in a crystal form was fixed, wherein PVA was a matrix.

### Test Example 1-1

### Absorption of Carbon Dioxide by Guanidine Derivative/PVA Blend Membrane

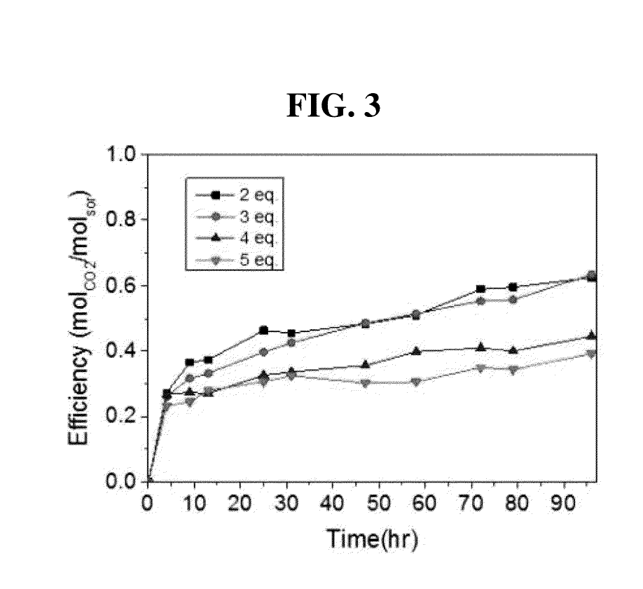

In order to evaluate reactivity with carbon dioxide at the time of preparing a membrane, blend membranes having various ratios between guanidine and functional groups of PVA ([the number of hydroxyl groups of PVA/the number of guanidines]) were prepared, and carbon dioxide was injected to the blend membranes. A predetermined amount of membrane was put into a flask, purged with nitrogen, and stabilized until change in mass was not observed, and absorption of carbon dioxide was observed by injecting carbon dioxide and analyzing change in mass at a predetermined time interval. As shown in FIG. 3, it could be appreciated that there was reactivity with carbon dioxide even in the prepared guanidine derivative/PVA blend membrane.

### Test Example 1-2

### Gas Separation Characteristic of Guanidine Derivative/PVA Blend Membrane

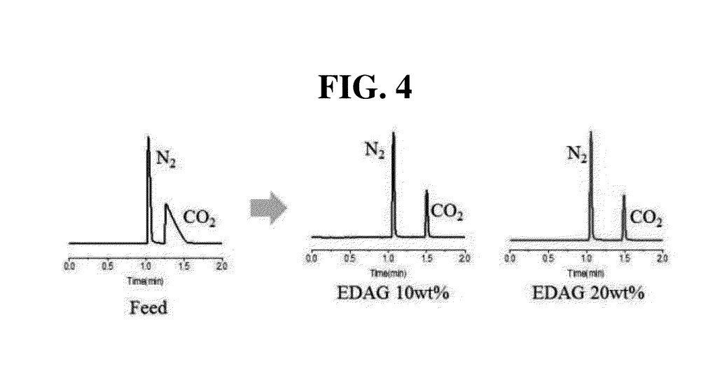

Two kinds of guanidine derivative/PVA blend membrane according to the content of guanidine derivative were prepared, and the gas separation characteristic was confirmed by gas chromatography (GC). In GC analysis, a mixed gas including nitrogen and carbon dioxide (50:50) was used, and helium gas was used as carrier gas. The analysis was performed under 1 bar of measurement pressure at room temperature. FIG. 4 is gas chromatography (GC) graph of a blend membrane containing 10 wt % of guanidine derivative and a blend membrane containing 20 wt % of guanidine derivative. In feed gas, it was shown that a peak of nitrogen and a peak of carbon dioxide had a ratio of 50:50. However, it could be confirmed in GC graph of the gas passing through the guanidine derivative/PVA blend membrane that the peak of nitrogen was similar to the peak of nitrogen in the feed gas, but the peak of carbon dioxide was reduced. It could be confirmed from the above results that nitrogen more favorably permeated than carbon dioxide to provide reverse selectivity.

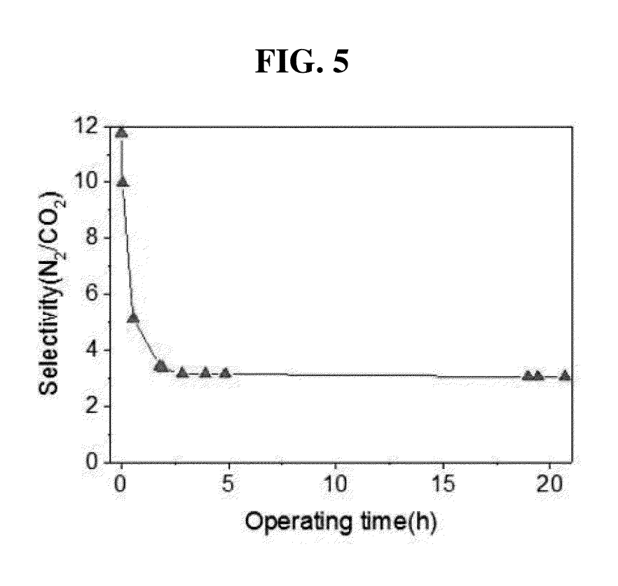

FIG. 5 is a graph showing selectivity of the guanidine derivative/PVA blend membrane (including 20 wt % of guanidine) over time. As shown in the graph, the selectivity was initially about 12, and gradually decreased over time, and maintained to be 3.

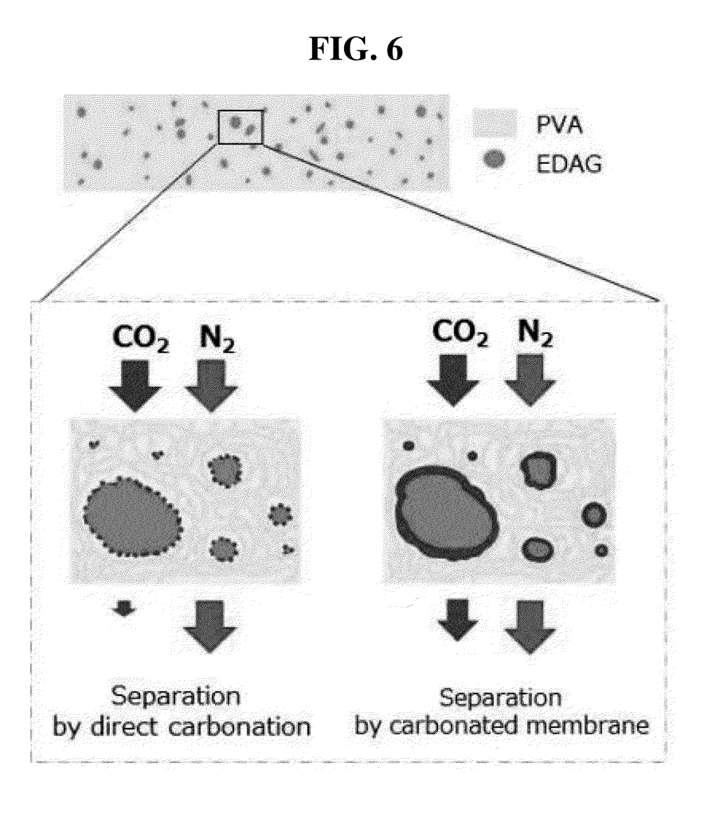

The reason in which the tendency shown in FIG. 5 appears, is present in FIG. 6. In the initial stage, the reaction with carbon dioxide is generated at a boundary in which the guanidine derivative is in contact with PVA rather than permeating carbon dioxide, to thereby cause carbonation, such that carbon dioxide is involved in the reaction and does not favorably permeates. On the contrary, it is seen that nitrogen may not react in the membrane, and thus, permeates. When all of carbon dioxides react and the carbonation is fully generated in the membrane, carbon dioxide permeates into non-carbonated portions, such that selectivity is gradually reduced, and has a constant value.

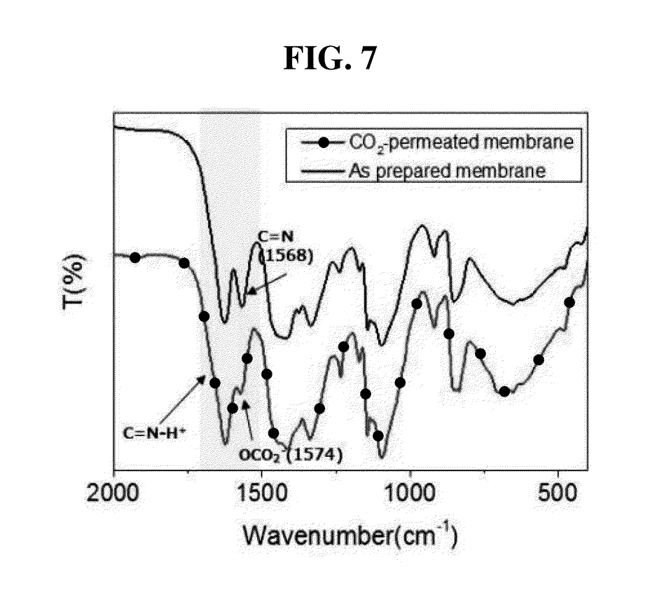

FIG. 7 is FT-IR graph of the guanidine derivative/PVA blend membrane. It may be confirmed from FT-IR graph that the carbonation is generated in the membrane. The blue line represents a FT-IR curve of the guanidine derivative/PVA blend membrane before carbon dioxide permeates, and the red line represents a FT-IR curve of the guanidine derivative/PVA blend membrane after carbon dioxide permeates. It was confirmed that after carbon dioxide permeated, the C═N peak shown at 1568 cm⁻¹ disappeared, and the C═N—H⁺ peak was slightly shown, and the OCO— peak could be confirmed at 1574 cm⁻¹. Accordingly, it could be appreciated that as carbon dioxide permeated through the guanidine derivative/PVA blend membrane, the carbonation was slightly generated even though it was not perfectly generated.

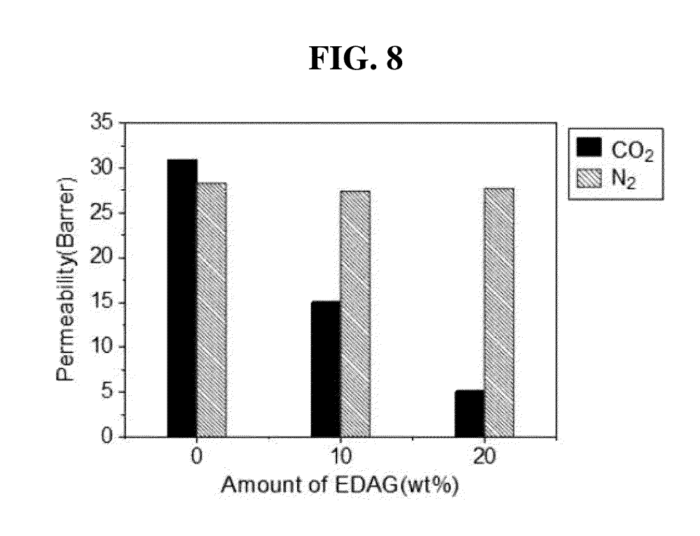

FIG. 8 is a graph showing permeability of single gas of the guanidine derivative/PVA blend membrane. Various kinds of membranes were prepared by adjusting the content of guanidine derivative to 0 wt %, 10 wt %, and 20 wt % based on total weight, and used for experiments. In the PVA film to which the guanidine derivative was not added, carbon dioxide a little bit more easily permeated than nitrogen, and permeability of nitrogen was similar to that of carbon dioxide. However, as the amount of guanidine derivative became increased in the membrane, the permeability of carbon dioxide was shown, but the permeability of nitrogen was constantly maintained. It was seen that as the amount of guanidine derivative became increased, points for carbonation in the membrane were increased, such that permeation of carbon dioxide was reduced; on the contrary, nitrogen that is not affected by carbonation, similarly permeated.

### Example 2

### Preparation of Guanidine Derivative/PVA Blend Membrane Treated with Carbon Dioxide

As reviewed above, it was confirmed that permeability of carbon dioxide was decreased as the degree of carbonation in the membrane was increased. Based on this confirmation, in order to carbonate the entire membrane instead of using a membrane in which the carbonation was locally generated in the membrane, a guanidine derivative/PVA blend membrane of which the entire was treated with carbon dioxide was prepared. PVA was purchased and dried for 12 hours at 100° C. to remove moisture. PVA was mixed with DMSO, and heated at 90° C. to be dissolved. When a clear solution was formed, various contents (5 wt % and 10 wt %) of guanidine derivatives were added thereto, and stirred until each guanidine derivative was completely dissolved.

The amount of the guanidine derivative and PVA were adjusted to about 15 wt % based on total weight of DMSO/guanidine/PVA. Then, each solution was made in the carbonation state by blowing carbon dioxide for about 30 minutes. Each solution in the carbonation state was casted on a polyethylene substrate, and dried under carbon dioxide atmosphere at 70° C. for 12 hours to obtain a membrane having a thickness of about 20 μm to 30 μm.

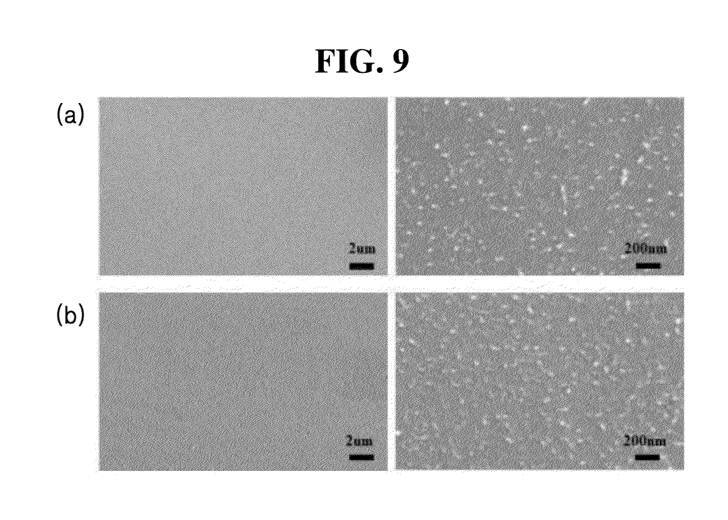

FIG. 9 is SEM images of guanidine derivative/PVA blend membranes treated with carbon dioxide. It could be confirmed that the guanidine derivative/PVA blend membrane had a relatively homogeneous and dense structure at a low magnification, and had a fibrous structure at a high magnification. As described above, it was considered that the structures were formed because guanidine, the PVA, and carbon dioxide reacted to form guanidinium carbonate, and gel was formed by crosslinking between the PVA chains while absorbing carbon dioxide.

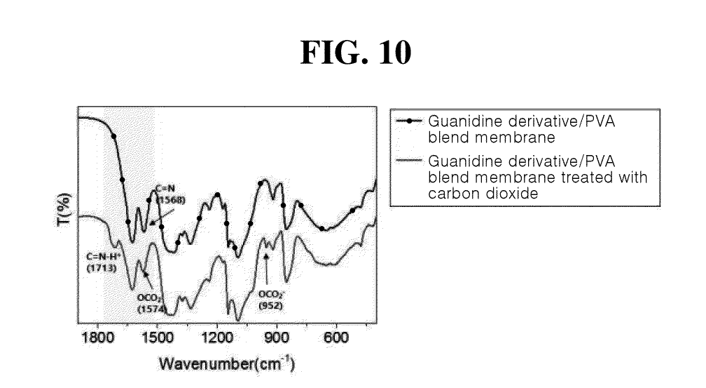

Further, FT-IR analysis was performed in order to confirm whether the carbonation was generated in the entire membrane. In FIG. 10, the blue line represents a FT-IR curve of the guanidine derivative/PVA blend membrane that is not treated with carbon dioxide, and the green line represents a FT-IR curve of the guanidine derivative/PVA blend membrane treated with carbon dioxide. There is a significant difference between the blue line and the green line as compared to the above-described FT-IR results. It could be confirmed that the C═N—H⁺ peak resulted from protonation of the C═N peak shown at 1568 cm⁻¹ was shown at 1713 cm⁻¹, and the OCO— peaks were shown at 1574 cm⁻¹ and 952 cm⁻¹. Accordingly, the reaction with carbon dioxide was already completely performed in the membrane itself, such that the membrane could be referred to as the carbonated membrane.

### Test Example 2

### Gas Separation Characteristic of Guanidine Derivative/PVA Blend Membrane Treated with Carbon Dioxide

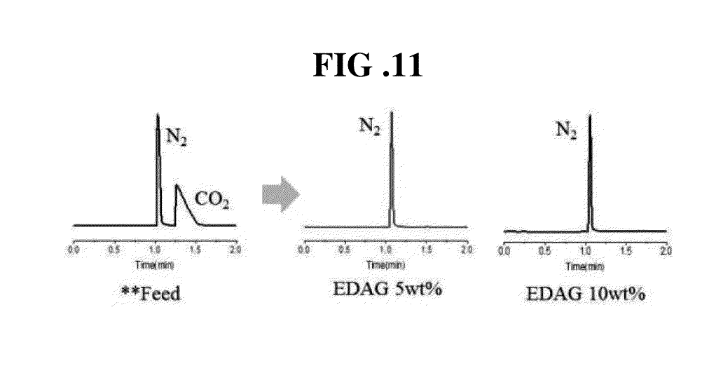

Gas separation characteristic of the guanidine derivative/PVA blend membrane treated with carbon dioxide was confirmed by gas chromatography (GC). In GC analysis, a mixed gas including nitrogen and carbon dioxide (50:50) was used, and helium gas was used as carrier gas. The analysis was performed under 1 bar of measurement pressure at room temperature. Two kinds of membranes were prepared by adjusting the content of guanidine derivative to 5 wt % and 10 wt %, and used for experiments. Upon reviewing GC graphs of the membrane to which 5 wt % of the guanidine derivative was added and the membrane to which 10 wt % of the guanidine derivative was added as shown in FIG. 11, it could be confirmed that the peak of carbon dioxide was rarely observed, unlike the feed gas. It was seen that since the entire membrane was carbonated, carbon dioxide was blocked; on the contrary, nitrogen that is not relevant to the carbonation permeated regardless of the carbonation.

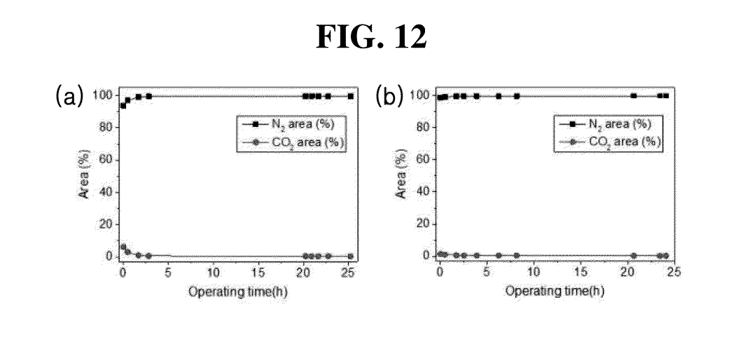

FIG. 12 shows integral values of nitrogen peaks and carbon dioxide peaks on GC graphs of FIG. 11 over time. The area of the nitrogen peak was converged to 100, and the area of carbon dioxide was converted to 0 and had constant values for about 24 hours. From the above results, it could be confirmed that carbon dioxide was blocked by the membrane due to the carbonation, rather than absorbing carbon dioxide in the membrane so that the carbon dioxide was not able to permeate. (If carbon dioxide is absorbed and does not permeate, it will show that the area of carbon dioxide peak becomes gradually decreased.)

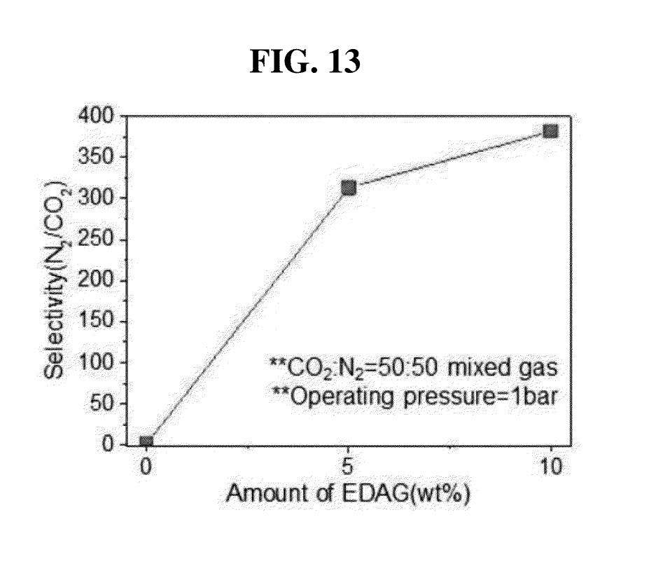

The guanidine derivative/PVA blend membrane treated with carbon dioxide is a membrane having reverse selectivity, where permeation of carbon dioxide is prevented but nitrogen only permeates by the carbonation phenomenon generated throughout the entire membrane. Selectivity values for nitrogen with various contents of guanidine derivatives were shown in FIG. 13. It could be confirmed that the guanidine derivative/PVA blend membrane treated with carbon dioxide and having 5 wt % of guanidine derivative had a selectivity of 313, and the guanidine derivative/PVA blend membrane treated with carbon dioxide and having 10 wt % of guanidine derivative had a selectivity of 380, and accordingly, both of the membranes had high selectivity.

Next, the permeability was measured by using single gases (carbon dioxide, nitrogen). As described above, in the PVA film, carbon dioxide a little bit more easily permeated than nitrogen, but permeability of nitrogen was similar to that of carbon dioxide. However, it was confirmed in the guanidine derivative/PVA blend membrane treated with carbon dioxide of the present invention that nitrogen permeated since it was not affected by carbonation, and carbon dioxide did not permeate even though the operating time was 48 hours or more.

According to various exemplary embodiments of the present invention, the gas separation membrane comprising the superbase may have an excellent effect in blocking permeation of carbon dioxide.

What is claimed is:

1. A blend membrane comprising:
(a) a polymer including hydroxyl groups in a main chain; and
(b) a superbase.

2. The blend membrane of claim 1, wherein the superbase is selected from the group consisting of guanidine-based compounds, amidine-based compounds, or mixtures thereof.

3. The blend membrane of claim 2, wherein the guanidine-based compound is at least one selected from the following compounds: 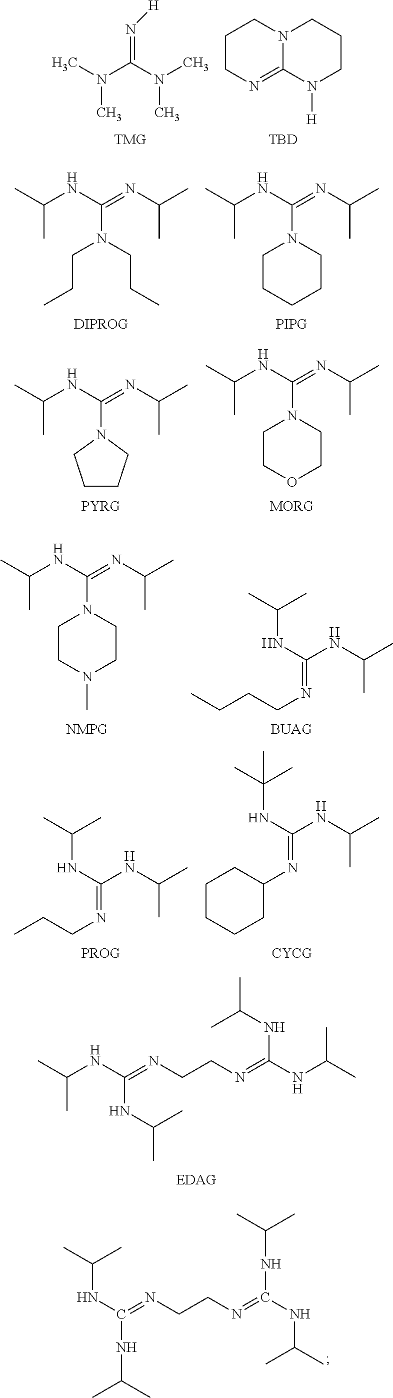
and
the amidine-based compound is at least one selected from the following compounds:

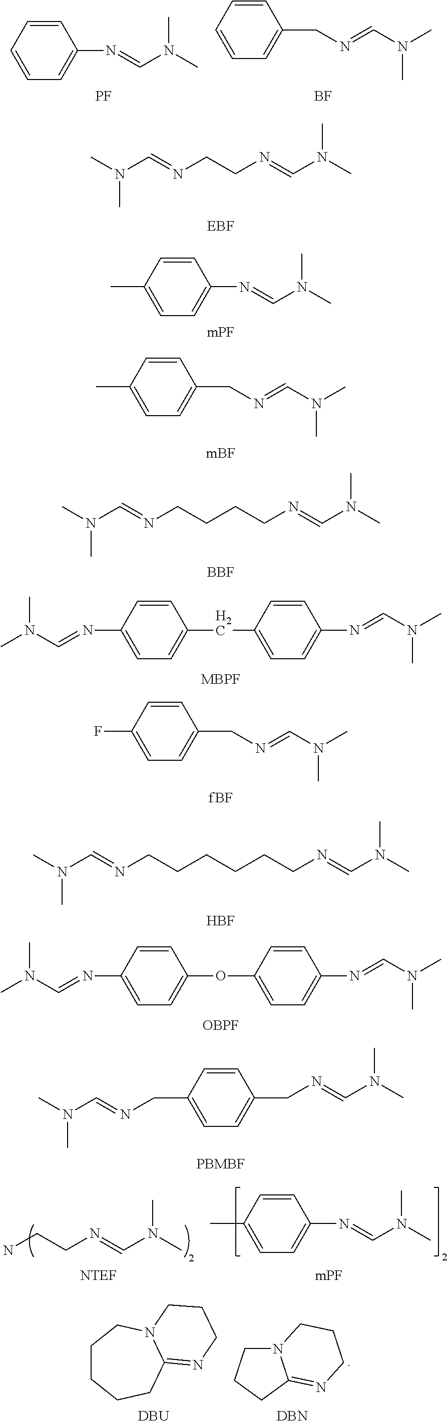

4. The blend membrane of claim 1, wherein the polymer is a polymer including vinyl alcohol as a repeating unit.

5. The blend membrane of claim 4, wherein the polymer is at least one selected from the following compounds:

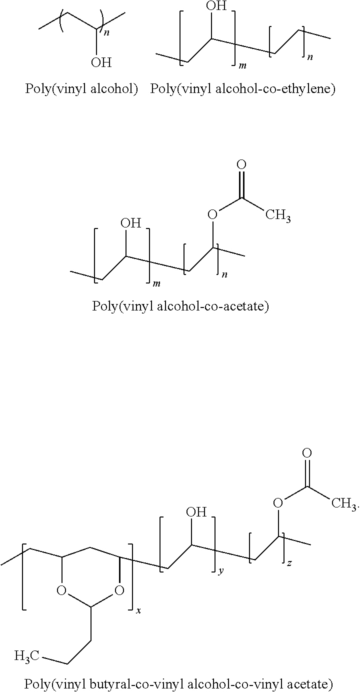

6. The blend membrane of claim 1, wherein some of the hydroxyl groups of the polymer are carbonated.

7. The blend membrane of claim 1, wherein the blend membrane has an effective peak for C═N—H⁺ functional group and an effective peak for OCO— functional group in FT-IR analysis results.

8. The blend membrane of claim 1, wherein the blend membrane has an effective peak for C═N—H⁺ functional group at 1700 cm⁻¹ to 1750 cm⁻¹ and an effective peak for OCO— functional group at 900 cm⁻¹ to 1000 cm⁻¹ in FT-IR analysis results.

9. The blend membrane of claim 8, wherein the blend membrane is used for blocking permeation of carbon dioxide.

10. A method for blocking carbon dioxide comprising:
(a) permeating a mixed gas including carbon dioxide through the blend membrane of claim 5.

11. A method for blocking carbon dioxide comprising:
(a) permeating a mixed gas including carbon dioxide through the blend membrane of claim 6.

12. A method for preparing a blend membrane comprising:
(B) drying a solution containing a polymer including hydroxyl groups in a main chain and a superbase.

13. The method of claim 12, wherein the drying is performed under nitrogen or carbon dioxide atmosphere.

14. The method of claim 13, before step (B), further comprising: (A) blowing carbon dioxide into the solution containing the polymer including hydroxyl groups in the main chain and the superbase.
